(19) United States
(12) Patent Application Publication
(10) Pub. No.: US 2024/0094363 A1
(43) Pub. Date: Mar. 21, 2024

(54) Method for Calibrating a Gated Camera, Control Unit for Carrying Out Such a Method, Calibrating Device Having Such a Control Unit and Motor Vehicle Having Such a Calibrating Device

(71) Applicant: Daimler Truck AG, Leinfelden-Echterdingen (DE)

(72) Inventor: Fridtjof STEIN, Ostfildern (DE)

(21) Appl. No.: 18/263,291

(22) PCT Filed: Jan. 28, 2022
(86) PCT No.: PCT/EP2022/052098

§ 371 Date: Jul. 27, 2023

(30) Foreign Application Priority Data
Feb. 2, 2021 (DE) 10 2021 000 508.2

(51) Int. Cl. G01S 7/497; G01S 17/86; G01S 17/931

(52) U.S. Cl. CPC G01S 7/497; G01S 17/86; G01S 17/931; G01S 17/10

(57) ABSTRACT

A method for calibrating a gated camera that has a lighting device and an optical sensor by a distance sensor system. A control of the lighting device and the optical sensor are temporally coordinated with each other where the coordinated control is associated with a visible distance range. An object is searched for on at least one boundary of the visible distance range. When the object is found on the at least one boundary, an object distance is defined as a distance of the object found relative to the gated camera by the distance sensor system. A target distance of the at least one boundary to the gated camera is compared with the object distance. The coordinated control is evaluated and/or changed on a basis of the comparison between the target distance and the object distance.

### BACKGROUND AND SUMMARY OF THE INVENTION

The invention relates to a method for calibrating a gated camera, a control unit for carrying out such a method, a calibrating device having such a control unit and a motor vehicle having such a calibrating device.

A method for calibrating a gated camera, in particular a lighting device, emerges from the European patent application with the publication number EP 3 308 193 B1. In this method, light pulses are transmitted by means of the lighting device. These transmitted light pulses are compared with a reference light pulse, and, based on this comparison, the lighting device is calibrated. However, in this method, the interaction of the lighting device and the optical sensor is not considered.

One principle when calibrating a technical system is that the dimensions of the environment in which the calibration is carried out and the dimensions of the environment in which the technical system is operated are as identical as possible. For distance measurements with distances of up to 200 m, this can only be achieved in a cost and space-saving manner with difficulty.

The object of the invention is to provide a method for calibrating a gated camera, a control unit for carrying out such a method, a calibrating device having such a control unit and a motor vehicle having such a calibrating device, wherein the mentioned disadvantages are at least partially resolved, preferably avoided.

The object is in particular solved by a method for calibrating a gated camera that has a lighting device and an optical sensor being carried out by means of a distance sensor system, wherein controlling the lighting device and the optical sensor are temporally coordinated with each other, and the coordinated control is associated with a visible distance range. An object is searched for on at least one boundary of the visible distance range, wherein, if an object is found on the at least one boundary of the visible distance range, an object distance is defined as a distance of the object found relative to the gated camera by means of the distance sensor system. A target distance of the at least one boundary to the gated camera is compared with the object distance, wherein the coordinated control is evaluated and/or changed on the basis of the comparison between the target distance and the object distance.

With the help of the method proposed here, it is advantageously possible to calibrate controlling the gated camera, in particular the lighting device and the optical sensor, in particular the distant boundary and/or a close boundary of the visible distance range, based on limited distance measurements, preferably one distance measurement. The measuring accuracy of the gated camera is thereby increased, and the regulatory requirements are fulfilled. The calibration in particular comprises the orchestration of the lighting device and the exposure control of the optical sensor.

Furthermore, it is advantageously possible to recognize and to compensate for ageing effects in the components of the gated camera, in particular the lighting device and the optical sensor, with the method. Preferably, a possible future failure of a component due to ageing effects is also recognized early, whereupon exchanging the respective components can be initiated.

Calibrating the gated camera that has the lighting device and the optical sensor also occurs while the motor vehicle that has the gated camera is travelling. The dimensions of the environment in which the calibration is carried out and the dimensions of the environment in which is the gated camera is operated are therefore identical.

Calibrating the gated camera that has the lighting device and the optical sensor ensures that the ageing effects and/or contamination of the lighting device and/or of the optical sensor do not distort the distance measurement. A running time displacement of 10 ns already results in an error of approx. 3 m for the distance measurement.

The method for producing recorded images by means of controlling a lighting device and an optical sensor so they are temporally coordinated with each other is a method known in particular as a gated imaging method; the optical sensor is in particular a camera that is only activated so as to be sensitive in a defined, limited period of time, which is referred to as “gated control.” The lighting device is correspondingly also only actuated in a defined, chosen period of time, in order to illuminate an object-side setting.

A predefined number of light impulses are in particular transmitted by the lighting device, preferably with a duration between 5 ns and 20 ns. The beginning and the end of the exposure of the optical sensor is coupled to the number and duration of the transmitted light impulses. As a result, a defined visible distance range can be detected by the optical sensor by means of temporal control, on one hand of the lighting device and on the other hand of the optical sensor with a correspondingly defined localized location, i.e., in particular a defined distance of a close and a distant boundary of the visible distance range, by the optical sensor. A localized location of the optical sensor and the camera is known from the construction of the gated camera. Preferably, a localized location between the camera and the optical sensor is also known, and is small in comparison to the distance of the camera or of the optical sensor to the visible distance range. In the context of the present technical teaching, a distance between the optical sensor and an object is therefore the same as a distance between the camera and the object.

Here, the visible distance range is the object-side region in three-dimensional space, which is shown by the number and duration of the light impulses of the light impulses in connection with the start and the end of the exposure of the optical sensor by means of the optical sensor in a two-dimensional recorded image on an image screen of the optical sensor.

If “object-side” is mentioned here and in the following, a region in real space is being discussed. If “image-side” is mentioned here and in the following, a region on the image screen of the optical sensor is being discussed. The visible distance range is provided on the object side. This corresponds to an image-side region on the image plane on allocated by the imaging laws as well as the temporal control of the lighting device and of the optical sensor.

Depending on the start and the end of the exposure of the optical sensor after the beginning of the illumination by the lighting device, light impulse photons hit the optical sensor. The further the visible distance range is spaced apart from the lighting device and the optical sensor, the longer the temporal duration is until a photon that is reflected in this distance range hits the optical sensor. The time between an end of the illumination and a beginning of the exposure therefore increases the further the visible distance range is spaced apart from the lighting device and from the optical sensor.

It is therefore in particular possible according to an embodiment of the method to define the location and the spatial width of the visible distance range, in particular a distance between the close boundary and the distant boundary of the visible distance range by a correspondingly suitable choice of the temporal control of the lighting device on one hand, and of the optical sensor on the other hand.

In a preferred embodiment of the method, the visible distance range is predetermined, wherein the temporal coordination of the lighting device on one hand and of the optical sensor on the other hand is correspondingly predetermined.

Advantageously, the target distance is defined from the coordinated control, or the coordinated control is defined from the target distance.

In a further preferred embodiment of the method, the object distance is preferably set as the at least one boundary of the visible distance range of the coordinated control, and therefore as the current target distance, if the object distance and the target distance should differ.

In a preferred embodiment, the lighting device is a laser. Alternatively or additionally, the optical sensor is preferably a camera.

According to a development of the invention, it is provided that the distance sensor system has at least one sensor, chosen from a group consisting of a stereo camera, a lidar sensor and a radar sensor. Defining the object distance in a simple manner is advantageously possible by means of such a sensor.

According to a development of the invention, it is provided that the distance sensor system has a sensor fusion device that is configured to fuse at least two sensor signals from at least two sensors into a fusion signal. The object distance is defined on the basis of the fusion signal.

The at least two sensors are preferably different from each other, in particular the at least two sensors differ in their respective designs and/or in their respective sensor principles.

Preferably, the at least two are chosen from the group consisting of a stereo camera, a lidar sensor and a radar sensor.

According to a development of the invention, it is provided that, by means of the sensor fusion device, a sensor signal of the optical sensor and at least one sensor signal of the distance sensor system are fused into the fusion signal.

According to a development of the invention, it is provided that the coordinated control is changed if an absolute difference between the target distance and the object distance is larger than a predetermined boundary difference. In particular, the coordinated control is only then changed if the absolute difference between the target distance and the object distance is larger than the predetermined boundary difference. Additionally, the coordinated control is not changed if the absolute difference between the target distance and the object distance is smaller than or the same as the predetermined boundary difference.

The absolute difference of two values corresponds to the sum of the difference of these two values. A positive distance between two values is therefore always defined by means of the absolute difference.

According to a development of the invention, it is provided that the control of the lighting device is evaluated and/or changed depending on the comparison between the target distance and the object distance.

In a preferred embodiment of the method, if a difference between the object distance and the target distance is determined, the control of the lighting device is changed such that the object distance and the target distance are identical.

According to a development of the invention, it is provided that, by means of a low-pass filter, a correction for changing the coordinated control is defined, depending on the comparison between the target distance and the object distance. Advantageously, gradual changes by ageing and environmental influences are compensated for by means of the low-pass filter.

The object is also solved by a control unit being provided that is configured to carry out a method according to the invention or a method according to one or more of the previously described embodiments. The control unit is preferably formed as a computing device, especially preferably as a computer or as a control unit, in particular as a control unit of a motor vehicle. In the context of the control unit, there are in particular the advantages that have already been discussed in the context of the method.

The control unit is preferably formed to be operatively connected with the gated camera, in particular with the lighting device and the optical sensor, and the distance sensor system, and is respectively configured for controlling these.

The object is also solved by a calibrating device being provided that has a gated camera that has a lighting device and an optical sensor, a distance sensor system and a control unit according to the invention or a control unit according to one or more of the previously described embodiments. In the context of the calibrating device, there are in particular the advantages that have already been discussed in the context of the method and of the control unit.

The control unit is preferably operatively connected with the gated camera, in particular with the lighting device and the optical sensor, and the distance sensor system and is respectively configured for controlling these.

The object is also solved by a motor vehicle having a calibrating device according to the invention or a calibrating device according to one or more of the previously described embodiments being provided. In the context of the motor vehicle, there are in particular the advantages that have already been discussed in the context of the method, the control unit and the calibrating device.

In an advantageous embodiment, the motor vehicle is formed as a lorry. However, it is also possible that the motor vehicle is a passenger motor vehicle, a commercial vehicle, or other motor vehicle.

The invention is illustrated in greater detail below by means of the drawings.

### BRIEF DESCRIPTION OF THE DRAWINGS

FIG. 1 is a schematic representation of an exemplary embodiment of a motor vehicle and an object on a distant boundary of a visible distance range;

FIG. 2 is a schematic representation of the exemplary embodiment of the motor vehicle and of the object on a close boundary of the visible distance range;

FIG. 3 is a flow chart of a first exemplary embodiment for calibrating a gated camera;

FIG. 4 is a flow chart of a second exemplary embodiment for calibrating a gated camera; and

FIG. 5 is a flow chart of a third exemplary embodiment for calibrating a gated camera.

### DETAILED DESCRIPTION OF THE DRAWINGS

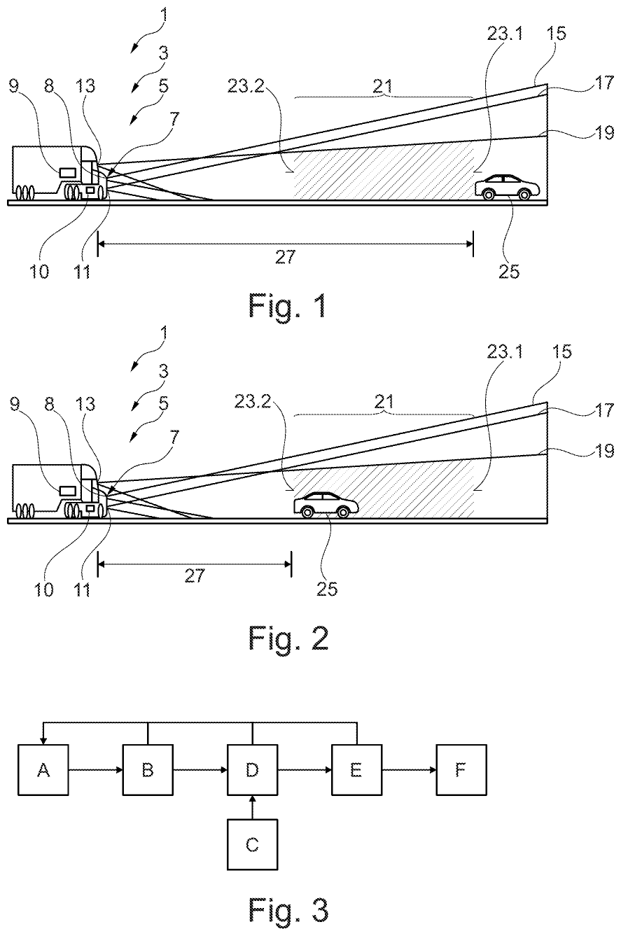

FIG. 1 shows a schematic representation of an exemplary embodiment of a motor vehicle 1 having a calibrating device 3. The calibrating device 3 has a gated camera 5, a distance sensor system 7 and a control unit 9. Furthermore, the gated camera 5 has a lighting device 11, preferably a laser, and an optical sensor 13, preferably a camera. The control unit 9 is here only shown schematically and is connected with the gated camera 5, in particular the lighting device 11 and the optical sensor 13, and the distance sensor system 7 in a manner that is not shown explicitly, and is configured for respectively controlling them. A sensor detection range 15 of the distance sensor system 7, a lighting frustum 17 of the lighting device 11 and an observation range 19 of the optical sensor 13 are in particular shown in FIG. 1. A visible distance range 21 is also shown with hatching, which arises as a part of the observation range 19 of the optical sensor 13 and of the lighting frustum 17 of the lighting device 11.

Preferably, the distance sensor system 7 has at least one sensor 8, chosen from a group consisting of a stereo camera, a lidar sensor, and a radar sensor. Alternatively or additionally, the distance sensor system 7 preferably has a sensor fusion device 10. The sensor fusion device 10 is configured in order to fuse at least two sensor signals from at least two sensors 8 into a fusion signal.

Preferably, the sensor fusion device 10 fuses at least two different sensor signals of the distance sensor system 7 into the fusion signal. Alternatively, the sensor fusion device 10 fuses at least one sensor signal of the distance sensor system 7 and one signal of the optical sensor 13 into the fusion signal.

An object 25, in particular a passenger motor vehicle, is arranged in the visible distance range 21, in particular on a distant boundary 23.1 of the visible distance range 21. An object distance 27 is preferably defined as the distance between the object 25 and the gated camera 5 by means of the distance sensor system 7.

The control unit 9 is in particular configured for carrying out a method for calibrating the gated camera 5 according to one of more of the exemplary embodiments described in FIGS. 3, 4 and 5.

FIG. 2 shows a schematic representation of the exemplary embodiment of a motor vehicle 1 having the calibrating device 3.

Identical and functionally identical elements are provided with the same reference numerals in all figures, so that in this way, reference is made to the preceding description in each case.

The object 25, in particular a passenger motor vehicle, is arranged in the visible distance range 21, in particular on a close boundary 23.2 of the visible distance range 21.

FIG. 3 shows a flow chart of a first exemplary embodiment of a method for calibrating the gated camera 5 by means of the distance sensor system 7.

In step A, a control of the lighting device 11 and of the optical sensor 13 are temporally coordinated with each other, wherein the coordinated control is associated with the visible distance range 21.

In step B, an object 25 is searched for on at least one boundary 23 of the visible distance range 21. If no object 25 is found, the method ends or the method is alternatively restarted with step A.

If, in step B, an object 25 is found on the at least one boundary 23 of the visible distance range 21, then in steps C and D, the object distances 27 are defined as a distance of the object found 25 relative to the gated camera 5 by means of the distance sensor system 7. Preferably, at least one sensor signal is detected in step C by means of the distance sensor system 7 and, in step D, the object distance 27 is preferably defined from the at least one sensor signal. If an object distance 27 cannot be defined in step D, then the method ends or the method is alternatively restarted with step A.

If the object distance 27 is defined in step D, then in step E, a target distance of the at least one boundary 23 of the visible distance range 21 to the gated camera is compared with the object distance 27. If a comparison cannot be carried out in step E, then the method ends or the method is alternatively restarted with step A.

In step F, the coordinated control, preferably the control of the lighting device 11, is evaluated and/or changed depending on the comparison between the target distance and the object distance 27 from step E.

An absolute difference between the target distance and the object distance 27 is preferably defined in step E. Furthermore, the coordinated control is then preferably only changed in step F if the absolute difference is larger than a predetermined boundary difference. The coordinated control of the gated camera 5 is therefore not changed in step F, if the absolute difference is smaller than or the same as the predetermined boundary difference.

An adjustment for changing the coordinated control depending on the comparison between the target distance and the object distance 27 is preferably defined in step F, by means of a low-pass filter.

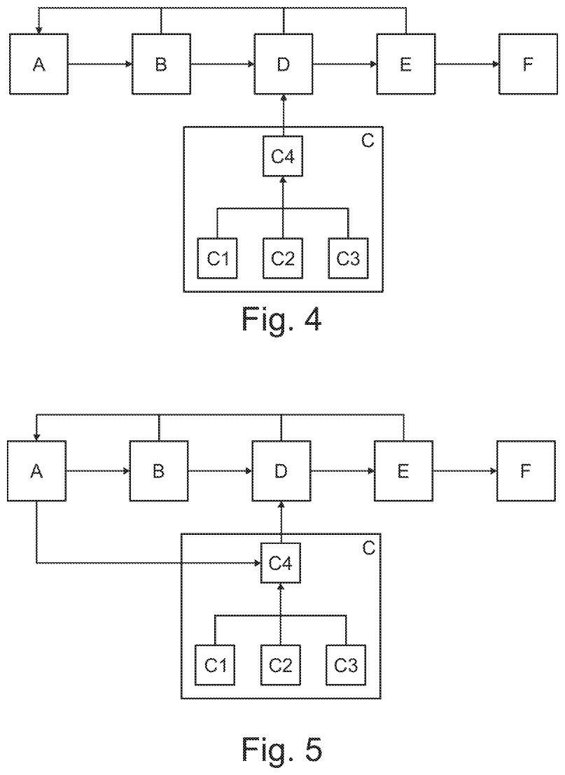

FIG. 4 shows a flow chart of a second exemplary embodiment of a method for calibrating the gated camera 5 by means of the distance sensor system 7.

Identical and functionally identical elements are provided with the same reference numerals in all figures, so that in this way, reference is made to the preceding description in each case.

In steps C1, C2 and C3, a plurality of sensor signals are detected by means of a plurality of sensors 8, in particular a first sensor, a second sensor and a third sensor, and are fused into a fusion signal in step C4 by means of the sensor fusion device 10. In step D, the object distance 27 is defined on the basis of the fusion signal. The individual sensors 8 of the plurality of sensors 8 are preferably different from each other.

FIG. 5 shows a flow chart of a third exemplary embodiment of a method for calibrating the gated camera 5 by means of the distance sensor system 7.

In step C4, the plurality of sensor signals and a signal of the optical sensor 13 are fused into the fusion signal.

1.-10. (canceled)

11. A method for calibrating a gated camera (5) that has a lighting device (11) and an optical sensor (13) by a distance sensor system (7), comprising:
a control of the lighting device (11) and the optical sensor (13) are temporally coordinated with each other, wherein the coordinated control is associated with a visible distance range (21);
an object (25) is searched for on at least one boundary (23) of the visible distance range (21);
when the object (25) is found on the at least one boundary (23) of the visible distance range (21), an object distance (27) is defined as a distance of the object found (25) relative to the gated camera (5) by the distance sensor system (7);
a target distance of the at least one boundary (23) to the gated camera (5) is compared with the object distance (27); and
the coordinated control is evaluated and/or changed on a basis of the comparison between the target distance and the object distance (27).

12. The method according to claim 11, wherein the distance sensor system (7) has at least one sensor (8) and wherein the at least one sensor (8) is a stereo camera, a lidar sensor, or a radar sensor.

13. The method according to claim 11, wherein the distance sensor system (7) has a sensor fusion device (10) that is configured to fuse at least two sensor signals from at least two sensors (8) into a fusion signal and wherein the object distance (27) is defined on a basis of the fusion signal.

14. The method according to claim 13, wherein, by the sensor fusion device (10), a sensor signal of the optical sensor (13) and at least one sensor signal of the distance sensor system (7) are fused into the fusion signal.

15. The method according to claim 11, wherein the coordinated control is changed when an absolute difference between the target distance and the object distance (27) is larger than a predetermined boundary difference.

16. The method according to claim 11, wherein the control of the lighting device (11) is evaluated and/or changed depending on the comparison between the target distance and the object distance (27).

17. The method according to claim 11, wherein, by a low-pass filter, a correction for changing the coordinated control is defined, depending on the comparison between the target distance and the object distance (27).

18. A control unit (9) configured to perform the method according to claim 11.

19. A calibrating device (3), comprising:
a gated camera (5) that has a lighting device (11) and an optical sensor (13);
a distance sensor system (7); and
a control unit (9) configured to perform the method according to claim 11.
